(19) United States
(12) Patent Application Publication
(10) Pub. No.: US 2003/0228424 A1
(43) Pub. Date: Dec. 11, 2003

(54) Water borne coating composition for film transfer and casting process

(76) Inventors: Clive Nicholas Dove, Blackburn (GB); John Sutcliffe, Todmorden (GB)

Correspondence Address: Lainie E. Parker, Akzo Nobel Inc., 7 Livingstone Avenue, Dobbs Ferry, NY, 10522-3408, US

(21) Appl. No.: 10/382,551

(22) Filed: Mar. 6, 2003

Related U.S. Application Data
(60) Provisional application No. 60/372,266, filed on Apr. 12, 2002.

(30) Foreign Application Priority Data
Mar. 6, 2002 (EP) 02251551.4

(51) Int. Cl. B05D 3/00

(52) U.S. Cl. 427/553

(57) ABSTRACT

A coating composition that can be used in a process for coating a substrate where, in a first step, a radiation curable coating composition is applied to the substrate and/or a radiation permeable film. In a subsequent step, the substrate and the film are pressed together in such a way that the coating composition is sandwiched between them. Thereafter, the coating composition is cured by irradiation through the film to obtain a coated substrate. Then, the transparent film is removed from the coated substrate. The coating composition that is applied to the film and/or the substrate is a radiation curable water borne coating composition comprising a radiation curable resin or a mixture of radiation curable resins.

This application claims the benefit of European Patent Application No. 02251551.4, filed Mar. 6, 2002, and U.S. Provisional Patent Application No. 60/372,266, filed Apr. 12, 2002.

### FIELD OF THE INVENTION

The present invention relates to a coating composition that can be used in a process for coating a substrate where in a first step a radiation curable coating is applied to the substrate and/or a radiation permeable film, next the substrate and the film are pressed together in such a way that the coating is sandwiched between them, thereafter the coating is cured by irradiation through the film to obtain a coated substrate, and in a subsequent step the film is removed from the coated substrate.

### BACKGROUND OF THE INVENTION

An example of such a process is described in U.S. Pat. No. 4,388,137. This patent publication discloses a process in which a coating composition is applied to a film before the film and a substrate are pressed together. Next, the coating composition is cured, followed by the film being stripped from the coated substrate. Such a process, in which a coating layer is transferred from a film to a substrate, is sometimes referred to as a film transfer process.

This US publication offers some general information regarding the selection of the coating compositions to be used in the process. Coating compositions without volatile organic compounds, or with only a low level of volatile organic compounds, are not mentioned.

During the drying and curing of coating compositions that contain volatile organic compounds, the main portion of these volatile organic compounds is emitted. Further, when total conversion of the components is not obtained, for instance in the case of UV cure, the uncured low-molecular weight organic molecules can cause environmental problems when the substrate is cut or sanded. Given present day environmental concerns and the corresponding legislation, there is a need for coating compositions without volatile organic compounds or with only a low level of volatile organic compounds.

In U.S. Pat. No. 4,113,894 a process is disclosed in which a substrate is coated with a radiation curable coating composition before a film is placed over the substrate. The substrate and film are irradiated together to cure the coating, after which the film is peeled from the substrate. In the current application, this type of coating process will be referred to as a casting process.

This US publication also does not mention coating compositions with a low level of volatile organic compounds or no volatile organic compounds at all.

In WO 80/01472 a process is disclosed in which a film is coated with a radiation curable coating composition, optionally followed by heating the coated film to evaporate non-polymerisable solvents from the coating. Subsequently, the coated film is applied to a substrate. The coating sandwiched between the film and the substrate is cured by UV radiation, after which the film is removed from the coated substrate. The coating compositions used in this process comprise a a high level of organic solvent and/or high level of reactive diluent, i.e. monomers that take part in the curing reaction.

A drawback of this method is that organic solvents may have to be evaporated. The use of reactive diluents reduces or eliminates VOC emission, as they are incorporated into the final film. However, they are known for their skin irritant and sensitising properties. Further, these components often have a strong or unpleasant odour and are suspect in view of their toxic properties.

A further problem when coating porous substrates e.g. wood, with compositions comprising reactive diluents is the penetration of the reactive monomers into the pores of the substrate. This is a drawback in particular when the coating is cured by radiation. Since the radiation does not reach these areas, uncured coating material in the pores of the substrate is the result. This can give health, safety, and environmental problems, e.g., when the substrate is cut or sanded. Release of free monomers from porous panels is known to occur even years after the lacquer has been applied.

The use of a process for coating a substrate where the coating composition is placed sandwiched between the substrate and a radiation permeable film and subsequently cured has several advantages over processes where such a film is absent. A major advantage lies in the fact that the surface configuration on the side of the film facing the coating layer can be imparted to the cured coating. This enables the manufacture of coated substrates with, in principle, any decorative effect. For example, it is possible to make a high gloss coated substrate by using a high gloss film. Low gloss substrates can be manufactured by using low gloss films, which has the advantage that it is not necessary to add a matting agent to the coating composition. It is also possible to manufacture textured coated substrates, for example substrates with a leather- or wood-like structure surface. Since the radiation curable coating is cured in the absence of oxygen, a more durable cured coating with improved (mechanical) properties is obtained.

### SUMMARY OF THE INVENTION

The present invention relates to a process for coating a substrate where in a first step a radiation curable coating composition is applied to the substrate and/or a radiation permeable film. In a subsequent step, the substrate and the film are pressed together in such a way that the coating composition is sandwiched between them. Thereafter, the coating composition is cured by irradiation through the film to obtain a coated substrate. Then, the film is removed from the coated substrate. The coating is a radiation curable water borne coating composition comprising a radiation curable resin or a mixture of radiation curable resins, which gives very good results when used in any of the above-mentioned processes. For example, this coating shows a good release of the film from the coated substrate after curing of the coating composition. Further, the coating composition can be used on a wide variety of substrates and in combination with a wide variety of films.

### DETAILED DESCRIPTION OF THE INVENTION

Within the framework of the present invention, a water borne coating composition is a coating composition which comprises at least 5 wt. % water, calculated on the total weight of the coating composition. Water-comprising coating compositions having a high solids content are included; these can be either heated or diluted with water before application. Such compositions are sometimes called water dilutable coating compositions.

Within the framework of the present invention, a dispersion or a dispersed system is an apparently homogeneous substance which consists of a microscopically heterogeneous mixture of two or more finely divided phases (solid, liquid or gaseous).

In view of present day environmental concerns, the use of a water borne composition is preferred, as it comprises a low level of volatile organic compounds or no volatile organic compounds at all. Preferably, the composition comprises <450 g/l, more preferably <350 g/l, even more preferably <250 g/l, highly preferred <100 grams of volatile organic compounds per litre of the composition. Ideally, the composition comprises no volatile organic compounds.

It was found that water borne dispersions are especially suitable in a process according to the present invention because the viscosity of dispersions is independent of the molecular weight of the polymers that are dispersed. Using coating compositions based on water borne dispersions it is thus much easier, by comparison with solvent borne coating compositions, to prepare a film comprising high molecular weight polymers with sufficient film thickness after removal of the carrier liquid. And, it is much easier, by comparison with solvent borne and high solids coating compositions, to prepare a low viscosity composition comprising relatively high molecular weight polymers. Additionally, the viscosity and rheology of a water borne dispersion can be adjusted with only small amounts of thickener and/or rheology modifier.

Furthermore, the waterborne coating composition can be adjusted with respect to the tackiness of a coating layer after drying and before radiation curing. For some applications it is advantageous to make use of an uncured waterborne composition that can be dried into a tacky film. For other applications it is advantageous to use an uncured waterborne coating composition which can be dried into a non-tacky film. For example, the substrate and/or the film used in a process according to the present invention may be pre-coated with a non-tacky film. Such a pre-coated substrate and/or film can be stored under suitable storing conditions for use in due time. When a water borne dispersion is dried into a non-tacky film it may not be re-dispersable. Thus, the dried dispersion may show less softening in case it comprises a small amount of water or certain weak solvents, or in case is moistened due to the environmental conditions under which it is stored.

Other advantages of a process according to the present invention, in which use is made of a radiation curable water borne coating composition, are that the process is very suitable to coat porous substrates, it requires a relatively small amount of photoinitiators, a relatively high amount of pigments can be present in the coating composition, the uncured coating composition can be allowed to re-flow after application and drying, and it is possible to coat two opposite sides of the substrate at the same time. All these advantages will be elaborated on below.

The water borne composition used in the process according to the present invention is radiation curable after application and, optionally, evaporation of solvents. Within the framework of the present invention, a radiation curable coating composition is a coating composition which is cured by using electromagnetic radiation having a wavelength λ≦500 nm or electron beam radiation. An example of electromagnetic radiation having a wavelength λ≦500 nm is UV radiation. Combinations of IR and UV radiation are also suitable for curing the water borne composition used in the process according to the present invention. Radiation sources which may be used are those customary for electron beam and UV. For example, UV sources such as high-, medium-, and low-pressure mercury lamps may be used. Also, for instance, gallium and other doped lamps may be used, especially for pigmented coatings. It is also possible to cure the hot melt composition by means of short light pulses.

In one embodiment of the present invention, especially when curing clear coats, the water borne coating composition is cured using low energy UV sources, i.e. by so-called daylight cure. The intensity of these lamps is lower than that of the aforementioned UV sources. Low energy UV sources hardly emit UV C; they predominantly emit UV A, and radiation with a wavelength at the border of UV B and UV A. Preferably the water borne coating composition is cured by radiation having a wavelength of 300 nm≦λ≦500 nm, more preferably 300 nm≦λ≦450 nm. For some compositions low energy UV sources emitting radiation having a wavelength of 370 nm≦λ≦450 nm can be preferred. Commercially available daylight cure lamps are for instance, solarium-type lamps, and specific fluorescent lamps such as TL03, TL05 or TL09 lamps (ex Philips) and BLB UV lamps (ex CLE Design).

The coating sandwiched between the substrate and the radiation permeable film is cured by irradiation through the film. If the coating is cured by electron beam, the film material is not critical, since penetration by the electrons can be assured by selecting a sufficiently high voltage. Consequently, in the case of cure by electron beam, the film can comprise, e.g., aluminium foil or an aluminised layer, for instance an aluminised polyester film, plastic or paper. If the coating is cured by UV radiation, the film has to be sufficiently transparent to the UV radiation for the coating to be cured. Consequently, in the case of cure by UV radiation, the film may comprise quartz glass or glass plate or a polymeric material, for example polyvinyl chloride, acetate, polyethylene, polyester, an acrylic polymer, polyethylene naphthalate, polyethylene terephthalate or polycarbonate. The film can be rigid or flexible, and may be of any desired thickness, as long as it permits sufficient transmission of the radiation to result in a sufficient cure of the coating composition.

Ideally, a coating is chosen that shows good release properties from the transfer or casting film. When there is good film release, the film can be removed from the coated substrate with the coating remaining virtually undamaged. The water borne coating compositions used in a process according to the present invention are suitable to be combined with a wide range of film types, including untreated films.

In order to ensure good release properties from the transfer or casting film, the film may be treated. The type of treatment of the film should be adjusted to the type of film and to the type of coating that is transferred or cast in the process according to the present invention. The film may for instance be coated with a release coating. Such a release coating may contain silicone or a fluoropolymer such as polytetra-fluoroethylene as release agent. U.S. Pat. No. 5,037,668 for instance describes a silicone-free fluoropolymer comprising an acrylate-type release coating.

It was found that the water borne composition used in the process according to the present invention is suited to be used on a wide variety of films and substrates. For instance, it can be applied to glass, ceramics such as ceramic tiles, and metals such as metal sheet, metal coil, and precoated metal sheets, for instance polyester precoated metal sheets. In particular, it can be used on heat-sensitive films and substrates, since it can be applied at relatively low temperatures. These films include cellulose-containing and plastic films. Examples of heat-sensitive substrates are wooden panels, veneer, fibreboards, paper, furniture foils, plastic parts, PVC, for instance PVC flooring, polyolefin flooring, linoleum flooring, and electric circuit boards.

If a porous substrate needs to be coated, it is advantageous to use a film transfer process. The film, which preferably is nonporous, is coated and dried, after which the coating is transferred to the porous substrate. Using this procedure, the amount of coating material required for coating the substrate is reduced, since less uncured coating material penetrates into the pores. Likewise, a minimum amount of coating material serves to prepare a smooth coating surface on a porous substrate when using a film with a smooth surface configuration on the side facing the substrate.

In principle any radiation curable resin or mixtures of resins can be used in the water borne composition used in the process according to the present invention. These resins are present in an amount of 20 to 95 wt. % of the composition. Preferably, the resin is present in an amount of 30 to 45 wt. %. Water is present in an amount of 5 to 80 wt. %, preferably 55 to 70 wt. %, calculated on the total weight of the coating composition.

Water borne radiation curable binders based on urethane, polyester, acrylic or epoxy backbones were found to be very suitable for use in the water borne coating composition in the process according to the present invention. Preferably, these water borne radiation curable binders are acrylate binders, i.e. binders having acrylate functionalities.

The composition may comprise a (meth)acryloyl-functional polyurethane dispersion. (Meth)acryloyl groups-containing polyurethane dispersions can be prepared using conventional polyurethane synthesis methods by conversion of polyisocyanates with hydroxyalkyl (meth)acrylates and a chain extender if desired. Suitable chain extenders include diols, polyols, dithiols, polythiols, diamines, and polyamines.

Examples of polyurethane and polyurethane/acrylic disperions are: Halwedrol UV 14, Halwedrol UV 20, Halwedrol UV 140, Halwedrol UV 160, Halwedrol UV-TN 6306, Halwedrol UV-TN 6711, Halwedrol UV-TN 5960, Halwedrol UV 55, Halwedrol UV 65, Halwedrol UV 6731, Halwedrol UV 6732, Halwedrol UV 6670, Halwedrol UV-TN 6957, Halwedrol UV-TN 6958, Halwedrol UV-TN 7143, Halwedrol UV-TN 7157, Halwedrol UV-TN 7200 (all ex Huettenes-Albertus), Laromer LR 8949, Laromer LR 8983, Laromer LR 9005 (all ex BASF), Neorad R 440, Neorad R 441, Neorad R 445, Neorad R 450 (all ex Neoresins), Viaktin VTE 6155w, Viaktin VTE 6165w, Viaktin VTE 6169w, Viaktin VTE 5972w (all ex Solutia), Ucecoat DW 7770, Ucecoat DW 7773, Ucecoat DW 7825, Ucecoat DW7900 (all ex UCB), Akzo Nobel EPC 6896, Akzo Nobel Actilane 640 (ex Akzo Nobel), Syntholux DRB 1014-W, Syntholux DRB 1114-W, Syntholux DRB 1192-W, Syntholux DRB 1199-W (all ex Synthopol Chemie), Lux 101, Lux 102, Lux 241, Lux 280, Lux 308, Lux 338, Lux 352, and Lux 399 (all ex Alberdingk Boley).

Examples of polyester acrylic dispersions are: Laromer PE 55 W, Laromer PE 55 WN, Laromer PE 22(all ex BASF), and Viaktin VTE 6166w (ex Solutia). An example of an epoxy acrylic dispersion is Jaegerlux 3150W (ex Eastman Jaeger). Examples of acrylic dispersions are Primal E-3120 (ex Rohm & Haas), Lux 384 and Lux 584 (both ex Alberdingk Boley). An example of a water dilutable urethane acrylic is Halwedrol UV 95 (ex Huettenes-Albertus). An example of a water dilutable polyester acrylic is Syncryl 2000W (ex Galstaff). An example of a water dilutable polyether acrylic is Syntholux DRB1077w (ex Synthopol Chemie). An example of a water dilutable epoxy acrylic is Laromer LR 8765 (ex BASF).

Preferably, the coating composition comprises a radiation curable unsaturated polyurethane resin, for instance polyurethane acrylate, and/or an unsaturated polyurethane/polyacrylate copolymer. Also an unsaturated modified polyurethane, such as a polyester modified polyurethane, is very suitable. Also preferred are coating compositions comprising a radiation curable unsaturated polyester, for instance polyester acrylate, or an unsaturated epoxy, for instance epoxy acrylate. An unsaturated polyester may be used together with for instance epoxy acrylate. Preferably, an unsaturated polyester is added to an unsaturated polyurethane dispersion.

More preferably, the coating composition comprises one or more radiation curable, water dilutable binders of the unsaturated polyurethane type, e.g., polyurethane acrylate, unsaturated polyester, e.g., polyester acrylate, and/or unsaturated epoxy, e.g., epoxy acrylate.

Most preferably, the coating composition comprises a radiation curable polyurethane acrylate dispersion in water and/or a modified polyurethane acrylate dispersion in water. Also highly suitable is a radiation curable polyester acrylate dispersion in water. Most preferred are coating compositions comprising a radiation curable epoxy acrylate dispersion in water.

Very good results have been obtained with coating compositions comprising 70-80 wt. %, calculated on the total weight of the coating composition, of a water borne radiation curable polyurethane/polyacrylate copolymer dispersion having a solids content of about 40%, calculated on the total weight of the dispersion, and 20-30 wt. %, calculated on the total weight of the coating composition, of a water borne radiation curable unsaturated polyurethane dispersion having a solids content of about 40%, calculated on the total weight of the dispersion.

Optionally, the coating composition used in the process according to the present invention comprises one or more reactive diluents. This can be advantageous when the composition comprises a (meth)acryloyl-functional polyurethane dispersion. Compounds suitable as reactive diluents generally are ethylenically unsaturated compounds. As representative examples may be mentioned those compounds disclosed in the previously incorporated EP-A-0 965 621. The reactive diluent preferably has a molecular weight of from about 80 to about 800, more preferably about 100 to about 400. Compounds meeting the molecular weight requirement are suitable for lowering the viscosity of the coating composition. Preferably, reactive diluents are used in an amount of 0 to 50 wt. % on solid resin, or 10 to 40 wt. %. Most preferably, the coating compositions comprise no reactive diluents at all.

Examples of monofunctional reactive diluents include the esters of acrylic and methacrylic acid, such as methyl (meth)acrylate, ethyl (meth)acrylate, propyl (meth)acrylate, isopropyl (meth)acrylate, butyl (meth)acrylate, isobutyl (meth)acrylate, tertiary butyl (meth)acrylate, neopentyl (meth)acrylate, isopentyl (meth)acrylate, n-hexyl (meth)acrylate, isohexyl (meth)acrylate, n-heptyl (meth)acrylate, iso-heptyl (meth)acrylate, octyl (meth)acrylate, iso-octyl (meth)acrylate, 2-ethylhexyl (meth)acrylate, nonyl (meth)acrylate, iso-nonyl (meth)acrylate, decyl (meth)acrylate, iso-decyl (meth)acrylate, undecyl (meth)acrylate, iso-undecyl (meth)acrylate, dodecyl (meth)acrylate, iso-dodecyl (meth)acrylate, tridecyl (meth)acrylate, iso-tridecyl (meth)acrylate, tetradecyl (meth)acrylate, iso-tetradecyl (meth)acrylate, and mixtures thereof. Moreover, the aforesaid esters of acrylic and methacrylic acid can contain radiation-reactive unsaturation in the alcohol radical as well. Additional monofunctional radiation-sensitive compounds which can be used as a reactive diluent include diallyl maleate, diallyl fumarate, vinyl acetate, and N-vinyl-2-pyrrolidone, especially the last compound.

The highly preferred reactive diluents in the coating composition are those having more than one radiation-sensitive bond. Such compounds ordinarily are the esters of acrylic or methacrylic acid and a polyhydric alcohol. Further suitable reactive diluents are reactive diluents containing polyethylene oxide. Examples of the aforesaid difunctional diluents are ethylene glycol diacrylate and dimethacrylate; isopropylene and propylene glycol diacrylate and dimethacrylate. Similarly, the diol diacrylates and dimethacrylates of butane, pentane, hexane, heptane, and so forth up to and including thirty-six carbon diols are useful in the present clear coats as reactive diluents. Of particular interest are 1,4-butane diol diacrylate, 1,6-hexane diol diacrylate, diethylene glycol diacrylate, trimethylol propane triacrylate, and pentaerythritol tetraacrylate. Thus far optimum results have been obtained with reactive diluents selected from the group of 3-methoxypropyl-, benzyl-, octyl-, 2-hydroxy-ethyl citraconimide, (meth)acrylate esters of butane diol, hexane diol, and trimethylol propane, the diacrylate ester of butanediol diglycidyl ether, ethoxylated trimethylol propane triacrylate, and the reaction product of α,α,α′,α′-tetramethyl xylene diisocyanate (TMXDI®) with 4-hydroxy butylacrylate and/or the esterification product of 1 mole of 2-hydroxyethyl acrylate and 2 moles of caprolactone, and/or methoxy polyethyleneoxide glycol having a molecular weight between 300 and 1,000.

Also, non-radiation curable water borne binders can be incorporated into the water borne coating composition. These binders may be used to modify the viscosity, tack, adhesion, or film forming properties of the water borne coating composition and/or to modify the general film properties of the cured coating, such as stain resistance, flexibility or adhesion.

Examples of polyurethane dispersions are: Neopac E 106, Neopac E-114, Neopac E-125, Neorez R-995, Neorez R-974, Neorez R-989, Neorez R-986 (all ex Neoresins), Incorez W830-360, Incorez W830-364, Incorez W830-140 (all ex Industrial Co-polymers, Liopur 93-127, Liopur 99-041, Liopur 97-094 (all ex Synthopol Chemie) Ucecoat DW 5461, Ucecoat DW 5562, Ucecoat DW 5568, Ucecoat DW 5861 (all ex UCB), Esacote PU114, Esacote PU51, Esacote PU10, Esacote PU21 (all ex Lamberti), and U930, U933 (ex Alberdingk Boley). Examples of acrylic dispersions are: Neocryl XK12, Neocryl XK14, Neocryl XK15, Neocryl A623, Neocryl A633, Neocryl A655 (all ex Neoresins), Primal E-2955, Primal WL91, Primal WL96 (all ex Rohm & Haas), Rhoplex WL92, Joncryl 8211, Joncryl 8224, Joncryl 8320 (all ex Johnson Polymer), and MAC24 (ex Alberdingk Boley).

Further, the composition can comprise a photoinitiator or a mixture of photo-initiators. Examples of suitable photoinitiators that can be used in the radiation curable composition according to the present invention are benzoin, benzoin ethers, α,α-dialkoxyacetophenones, α-hydroxyalkylphenones, α-aminoalkylphenones, acylphosphine oxides, methylbenzoylformate, benzophenone, thioxanthones, 1,2-diketones, and mixtures thereof. Commercially available examples are: Esacure® KIP 100F and Esacure® KIP EM (ex Lamberti), Genocure® CQ, Genocure® CQ SE, Genocure® EHA, Quantacure® BMS, Quantacure® EPD (ex Rahn), Irgacure® 184, Irgacure® 651, Irgacure® 500, Irgacure® 369, Irgacure® 819, and Darocure® 2959 (ex Ciba), Speedcure® ITX, Speedcure® BKL, Speedcure® BMDS, Speedcure® PBZ, Speedcure® BEDB, and Speedcure® DETX (ex Lambson), Genocure® MBF (ex Rahn), and Lucirin® TPO (ex BASF).

However, the presence of a photoinitiator is not necessary. In general, when electron beam radiation is used to cure the composition, it is not necessary to add a photoinitiator. When UV radiation is used, in general a photoinitiator is added. Although the total amount of photoinitiator in the composition is not critical, it should be sufficient to achieve acceptable curing of the coating when it is irradiated. However, the amount should not be so large that it affects the properties of the cured composition in a negative way. In general, the composition should comprise between 0 and 10 wt. % of photoinitiator, preferably from 0.5 to 5 wt. %, more preferably from 0.1 to 2 wt. %, calculated on the total weight of the composition. As a rule, compared to the amount necessary when the coating is applied to a substrate and subsequently cured, in the process according to the present invention a smaller amount of photoinitiator can be used to achieve acceptable curing. This effect might be due to the film on top of the coating that prevents the initiated radicals from being caught by oxygen in the air.

When the coating composition is cured by a low energy UV source, it is preferred to add an aminobenzoate co-initiator to the waterborne coating composition. The aminobenzoate co-initiator preferably absorbs radiation having a wavelength between 275 and 350 nm. Preferably the aminobenzoate co-initiator is liquid at room temperature.

The composition can also contain one or more fillers or additives. The fillers can be any fillers known to those skilled in the art, e.g., barium sulphate, calcium sulphate, calcium carbonate, silicas or silicates (such as talc, feldspar, and china clay). Additives such as aluminium oxide, silicon carbide for instance carborundum, ceramic particles, glass particles, stabilisers, dispersants, antioxidants, levelling agents, anti-settling agents, anti-static agents, matting agents, rheology modifiers, surface-active agents, amine synergists, waxes, or adhesion promoters can also be added. In general, the water borne coating composition used in the process according to the present invention comprises 0 to 40 wt. %, preferably 10 to 30 wt % of fillers and/or additives, calculated on the total weight of the coating composition.

The water borne composition used in the process according to the present invention can also contain one or more pigments. In principle, all pigments known to those skilled in the art can be used. However, care should be taken that the pigment does not show a too high absorption of the radiation used to cure the composition. In general, the water borne composition comprises 0 to 40 wt. %, preferably 10-30 wt. % of pigment, calculated on the total weight of the coating composition. Because of the film on top of the coating that reduces the initiated radicals from being caught by oxygen in the air, acceptable curing of a pigmented coating can be reached even when the coating comprises a relatively large amount of pigments.

In addition to the compounds mentioned above, the radiation curable water borne composition used in the process according to the present invention can also comprise monomers or volatile organic compounds. However, the amount of such compounds should be as low as possible.

The water borne coating composition can generally be prepared by mixing the components using any suitable technique. Normally, the components are mixed until a homogeneous mixture is obtained. The mixing can be done in air. Care should be taken that during the mixing of the components the shear stress and/or the temperature does not become so high as to cause degradation or flocculation of any of the components. Needless to say, the mixing should be performed in the absence of any radiation that could initiate curing of the coating.

Equipment known to those skilled in the art can be used to apply the water borne coating, e.g. a roller coater, a bead coater, a spraygun or a curtain coater. Also suitable contact and non-contact printing techniques, as well as deposition coating techniques, can be used to apply these compositions. After the water borne coating composition is applied to the substrate and/or to the film, water is removed from the coating. For instance, the coating may be dried, either naturally or forced. This process can also be used to prepare a pre-coated film or a pre-coated substrate.

In a next step, the substrate and the film are pressed together in such a way that the coating is sandwiched between them. Alternatively, the whole process starts with pressing a pre-coated film and a substrate together in such a way that the coating is sandwiched between them. The surface of the coating sandwiched between the substrate and the film may conform to the surface configuration on the side of the film facing the coating layer. It is also possible to emboss a flexible film in order to impart a pattern to the coating.

Before, during and/or after the substrate and the film are pressed together, the film and/or the substrate are heated in order to soften the coating until it will flow again. Such re-flow facilitates the imparting of the surface configuration on the side of the film facing the coating layer to the coating layer. The heating temperature preferably is between 40 and 100° C., more preferably between 40 and 90° C., even more preferably between 50 and 80° C. Preferably, a pressure is applied to the softened coating layer in order to force the softened coating to flow. For instance, a water borne composition can be applied on a substrate and then left to dry. Next, a film can be put on top of the coating, followed by pressing the substrate and the film together using conventional hot pressing means, such as a pair of heated calender rolls. This way the coating layer will re-flow.

In a next step, the coating sandwiched between the substrate and the film is cured by irradiation through the film, followed by removal of the film from the coated substrate.

In one embodiment, after application of the radiation curable coating to the substrate and/or the transparent film, the substrate and/or the transparent film is dried, for instance by heating, to get a tack-free substrate and/or film. As described above, this process can also be used to prepare a pre-coated substrate and/or a pre-coated film. Such a pre-coated substrate and/or film can be stored under suitable storing conditions for use in due time.

In another embodiment, after application of the radiation curable coating to the substrate and/or the transparent film, the substrate and/or the transparent film is dried, for instance by heating, to get a tacky substrate and/or film. This embodiment is preferably performed using a waterborne coating composition comprising a low amount of water, for example comprising 5 to 20 wt. % water, more preferably comprising 5 to 15 wt. % water, most preferred 5 to 10% water, calculated on the total weight of the coating composition. After drying, the substrate and the film can be pressed together using conventional pressing means, such as a pair of calender rolls. Since re-flow is not necessary in this case, the pressing means do not have to be heated.

If the water borne composition is applied to a substrate in a film transfer process, it is possible to coat two opposite sides of the substrate at the same time. Two films are coated, dried, and subsequently pressed onto two sides of the substrate. After curing of the two coating layers by irradiation through both films, the films are removed from the double-coated substrate.

If the water borne composition is applied to one side of a substrate in a casting process, it is possible to coat the opposite side of the substrate by means of a film transfer process at the same time.

Preferably, the film used in the film transfer process is flexible. The flexible film may constitute a continuous, and preferably seamless, loop or a reel of film which can be used and retreated. In a continuous loop process or a reel process, part of the film is coated and the coating is given the time to (partially) dry, using drying means such as moving air or heat if necessary. Alternatively, use may be made of a pre-coated loop or reel of film, i.e. an off-line pre-coated film. Subsequently, the coated film is placed on a substrate. Said substrate is then subjected to radiation, for instance UV or electron beam radiation, to cure the coating. Then the film is removed from the coated substrate. Next, the film returns to be recoated in the continuous loop process, or the film is rewound and sent for recoating in the reel process. Alternatively, the film is left in place on the coated substrate to offer process protection until its removal is convenient or required.

In these film transfer processes the substrate may be in the form of separate sheets or plates. Alternatively, the substrate may be a flexible film as well. In that case the substrate may be dereeled before entering the film transfer process and rereeled after being coated.

Preferably, the film used in the casting process is flexible. The flexible film may be a reel of film which can be used and retreated. For example, the film may be reeled off a roll onto the coated substrate. After curing of the coating, the film is removed from the coated substrate and may subsequently be rewound onto a roll. Next, the process can be repeated using the rereeled film.

In such a casting process, the substrate may be in the form of separate sheets or plates. Alternatively, the substrate itself may be a flexible film which can be dereeled before entering the casting transfer process and rereeled after being coated.

Using a process according to the present invention, it is possible to apply one or more coating layers of the water borne composition to a substrate. The process is particularly useful for applying a top coat to an optionally coated substrate. In principle, there is no restriction as to the coating composition(s) that may have been applied to a substrate, as long as there is good adhesion between the coating on top of the substrate and the (cured) water borne composition. The same type(s) of coating composition(s) can be used for the optional pre-coating layer(s) as for the top coat layer, although the composition of this/these coating layer(s) and of the top coating composition need not be the same. The pre-coating layer(s) can be applied to the substrate by conventional means, such as by curtain coater, spray nozzle, roller coater, or flow coater. Also suitable contact and non-contact printing techniques, as well as deposition coating techniques, can be used to apply these compositions.

The invention will be elucidated with reference to the following examples. These are intended to illustrate the invention but are not to be construed as limiting in any manner the scope thereof.

### EXAMPLES

Several water borne compositions were prepared according to the following formulation in which the percentages are weight percentages based on the total weight of the composition.

Formulation 1

| | |
|---|---|
| Water borne radiation curable polyurethane/polyacrylate copoly- | ≈77% |
| mer dispersion (40% solids content) | |
| Water borne radiation curable unsaturated polyurethane | ≈20% |
| dispersion (40% solids content) | |
| Benzophenone | <1.5% |
| α-Hydroxy ketone | <1.5% |
| Additives | <0.5% |

Several compositions according to Formulation 1 were prepared having a solids content of 30-40%, and a viscosity of <100 mPa.s at 21° C.

Formulation 2

| | |
|---|---|
| Water borne radiation curable acrylate functional aliphatic | ≈43% |
| urethane dispersion | |
| Water borne radiation curable acrylic dispersion | 29% |
| Matting agent (optional) | ≈3% |
| Water | ≈16% |
| Co-solvent | ≈2% |
| Wax dispersion | ≈4% |
| Additives | <0.7% |
| Thickener | <1% |
| Photoinitiator | ≈2.5% |

Several compositions according to Formulation 2 were prepared having a solids content of 30-40%, and a viscosity of 300-500 mPa.s at 21° C.

Formulation 3

| | |
|---|---|
| Water borne radiation curable aliphatic urethane acrylate | ≈45% |
| dispersion | |
| Water borne radiation curable flexible polyurethane acrylate | ≈10% |
| dispersion | |
| Water borne radiation curable acrylic dispersion | ≈18% |
| Matting agent (optional) | ≈3% |
| Water | ≈14% |
| Co-solvent | ≈2% |
| Wax dispersion | ≈4% |
| Additives | ≈2% |
| Thickener | ≈1% |
| Photoinitiator | ≈2.5% |

Several compositions according to Formulation 3 were prepared having a solids content of 30-40%, and a viscosity of 300-500 mPa.s at 21° C.

Formulation 4

| | |
|---|---|
| Water borne radiation curable aliphatic polyester urethane | ≈20% |
| acrylate dispersion | |
| Water borne radiation curable urethane resin dispersion | ≈30% |
| Water borne radiation curable acrylic dispersion | ≈35% |
| Thermoplastic acrylic dispersion | <6% |
| Matting agents | ≈4% |
| Additives | ≈1% |
| Thickener | <0.5% |
| Photoinitiators | ≈2% |

Several compositions according to Formulation 4 were prepared having a solids content of 35-45%, and a viscosity of 500-1,500 mPa.s at 21° C.

Several water dilutable compositions were prepared according to the following formulation in which the percentages are weight percentages based on the total weight of the composition.

Formulation 5

| | |
|---|---|
| Water borne radiation curable polyester acrylate dispersion | ≈56% |
| Radiation curable unsaturated polyester (water dilutable) | ≈15% |
| Additives | <0.2% |
| Photoinitiator | <2% |
| Diluents | ≈30% |

Several compositions according to Formulation 5 were prepared having a solids content of 43%, and a viscosity of 80-200 mPa.s at 21° C.

Formulation 6

| | |
|---|---|
| Water borne radiation curable polyester acrylate dispersion | ≈80% |
| Radiation curable epoxy acrylate (water dilutable) | ≈20% |
| Additives | <0.2% |
| Photoinitiator | <2% |

Several compositions according to Formulation 6 were prepared having a solids content of 60%, and a viscosity of 300-500 mPa.s at 21° C.

Formulation 7

| | |
|---|---|
| Water borne radiation curable aliphatic urethane acrylate | ≈41% |
| dispersion | |
| Radiation curable polyurethane/polyether acrylate (water di- | ≈41% |
| lutable) | |
| Water borne radiation curable aromatic urethane acrylate | ≈12% |
| dispersion | |
| Additives | <0.5% |
| Photoinitiator | <3% |

Several compositions according to Formulation 7 were prepared having a solids content of 50-70%, and a viscosity of 500-1,500 mPa.s at 21° C.

| Formulation 8 | |
|---|---|
| Anionic, radiation curable polyurethane dispersion | 93.7% |
| Slip and flow additive | 0.3% |
| Alpha-amino ketone photoinitiator solution (20% in Toluene) | 6.0% |
| Formulation 9 | |
| Anionic, radiation curable polyurethane dispersion | 98.2% |
| BAPO dispersion photoinitiator | 1.5% |
| Slip and flow additive | 0.3% |
| Formulation 10 | |
| Waterborne radiation curable polyurethane/polyacrylate copoly- | 73.6% |
| mer dispersion (40% solids content) | |
| Waterborne radiation curable unsaturated polyurethane disper- | 20.0% |
| sion (40% solids content) | |
| Slip and flow additives | 0.3% |
| Aminobenzoate co-initiator | 3.0% |
| Benzophenone | 3.0% |
| Formulation 11 | |
| Anionic dispersion of a radiation curing polyurethane resin | 93.4% |
| (40% solids content) | |
| Slip and flow additive | 0.3% |
| Aminobenzoate co-initiator | 3.0% |
| Benzophenone | 3.0% |
| Thickener | 0.3% |

Several compositions according to Formulations 8-11 were prepared having a solids content of 35 to 45%, and a viscosity of 100 to 200 mPa.s at 21° C.

The compositions were applied to substrates by means of a casting process or a film transfer process. The compositions were applied to a substrate and/or to a film at ambient temperature. Next, the coated substrates and films were dried using moving air, warm moving air or infra-red radiation. Subsequently, the substrate and the film were pressed together at a temperature between 50 and 100° C. to allow the coating to re-flow when required.

Each coating composition sandwiched between a substrate and a film was cured through the radiation permeable film using UV radiation. Medium-pressure 120 W/cm mercury lamps were used to irradiate the substrates coated with coating compositions according to Formulations 1-7. Low energy UV lamps emitting radiation having a wavelength between 300 and 500 nm, and showing a maximum in the UV emission band at around 350 nm, were used to irradiate the substrates coated with compositions according to Formulations 8-11.

After removal of the film, the properties of the cured coating layers on top of the substrates were tested. The test results for the samples prepared using compositions according to Formulations 1 to 7 are summarised in Table 1.

TABLE 1

| | |
|---|---|
| Stain resistance | Good |
| Scuff and scratch resistance | Good |
| Solvent resistance | Superior |
| Photo yellowing | Low |

The test results for the samples prepared using compositions according to Formulations 8 and 9 are summarised in Table 2.

TABLE 2

| | |
|---|---|
| Stain resistance | Good |
| Scuff and scratch resistance | Good |
| Solvent resistance | Superior |
| Photo yellowing | Yellowing during cure |

The test results for the samples prepared using compositions according to Formulations 10 and 11 are summarised in Table 3.

TABLE 3

| | |
|---|---|
| Stain resistance | Good |
| Scuff and scratch resistance | Good |
| Solvent resistance | Superior |
| Photo yellowing | Low |

It proved to be possible to adjust the flexibility of the coatings such that it suited the flexibility of the substrate.

Compositions according to Formulation 1 proved to be particularly suitable to be used for coating a variety of substrates such as paper, furniture foils, flooring, and furniture.

Compositions according to Formulations 2, 3, and 4 proved to be particularly suitable to be used for coating furniture foils and flooring.

Compositions according to Formulation 5 proved to be particularly suitable to be used for coating furniture and exterior joinery.

Compositions according to Formulation 6 proved to be particularly suitable to be used for coating furniture.

Compositions according to Formulation 7 proved to be particularly suitable to be used for coating paper and furniture foils.

Compositions according to Formulations 8-11 proved to be particularly suitable to be used for paper, furniture, furniture foils, flooring (wood and polymeric).

1. A process for coating a substrate comprising a first step of applying a radiation curable coating composition to the substrate and/or a radiation permeable film, the coating composition being a radiation curable water borne coating composition comprising a radiation curable resin or a mixture of radiation curable resins; a subsequent step of pressing the substrate and the film together to sandwich the coating composition between them; thereafter curing the coating composition by irradiation through the film to obtain a coated substrate; and then removing the film from the coated substrate.

2. The process according to claim 1, wherein the coating composition comprises a radiation curable unsaturated polyurethane and/or a radiation curable unsaturated modified polyurethane.

3. The process according to claim 2, wherein the unsaturated polyurethane is a polyurethane acrylate dispersion and the modified unsaturated polyurethane is a modified polyurethane acrylate dispersion.

4. The process according to claim 1, wherein the coating composition comprises a radiation curable unsaturated polyester.

5. The process according to claim 4, wherein the unsaturated polyester is a polyester acrylate dispersion.

6. The process according to claim 1, wherein the coating composition comprises a radiation curable unsaturated epoxy.

7. The process according to claim 6, wherein the unsaturated epoxy is an epoxy acrylate dispersion.

8. The process according to claim 1, wherein the coating composition comprises an unsaturated polyurethane/polyacrylate copolymer and/or an unsaturated modified polyurethane/polyacrylate copolymer.

9. The process according to claim 1, wherein the coating composition comprises 70-80 wt. %, calculated on the total weight of the coating composition, of a water borne radiation curable, optionally modified, polyurethane/polyacrylate copolymer dispersion having a solids content of 40%, calculated on the total weight of the dispersion, and 20-30 wt. %, calculated on the total weight of the coating composition, of a water borne radiation curable, optionally modified, unsaturated polyurethane dispersion having a solids content of 40%, calculated on the total weight of the dispersion.

10. The process according to claim 1, wherein the curing by irradiation is performed using a low energy UV source or a medium-pressure mercury lamp.

11. A process for coating a substrate comprising applying a radiation curable water borne coating composition to the substrate and/or a radiation permeable film; removing water from the coating; pressing the substrate and the film together to sandwich the coating composition between them; curing the coating composition by irradiation through the film to obtain a coated substrate; and removing the film from the coated substrate.
